(19) United States
(12) Patent Application Publication
(10) Pub. No.: US 2016/0061771 A1
(43) Pub. Date: Mar. 3, 2016

(54) GAS CONCENTRATION DETECTING DEVICE

(71) Applicant: TOYOTA JIDOSHA KABUSHIKI KAISHA, Toyota-shi (JP)

(72) Inventors: Keigo MIZUTANI, Nishio (JP); Hironobu SHOMOKAWA, Okazaki-shi (JP); Kazuhiro WAKAO, Susono-shi (JP); Tatsuhiro HASHIDA, Shizuoka-ken (JP); Keiichiro AOKI, Shizuoka-ken (JP)

(73) Assignee: TOYOTA JIDOSHA KABUSHIKI KAISHA, Toyota-shi (JP)

(21) Appl. No.: 14/840,382

(22) Filed: Aug. 31, 2015

(30) Foreign Application Priority Data
Sep. 1, 2014 (JP) 2014-177090

(51) Int. Cl. G01N 27/419; G01N 27/41

(52) U.S. Cl. CPC G01N 27/419; G01N 27/41

(57) ABSTRACT

A gas concentration detecting device includes a gas concentration detecting element and an electronic control unit. The gas concentration detecting element includes a first electrochemical cell. The electronic control unit is configured to detect the concentration of the sulfur oxide contained in the test gas based on a first detected value correlated with a current flowing through the first electrochemical cell acquired when a first predetermined voltage is applied to the first electrochemical cell. The first predetermined voltage is a voltage at which the water and the sulfur oxide contained in the test gas are decomposed in the first electrode of the first electrochemical cell.

### INCORPORATION BY REFERENCE

The disclosure of Japanese Patent Application No. 2014-177090 filed on Sep. 1, 2014 including the specification, drawings and abstract is incorporated herein by reference in its entirety.

### BACKGROUND OF THE INVENTION

1. Field of the Invention

The invention relates to a gas concentration detecting device that is capable of acquiring the accurate concentration of the sulfur oxide (SOx) contained in exhaust gas from an internal combustion engine.

2. Description of Related Art

An air-fuel ratio sensor (A/F sensor) that acquires the air-fuel ratio (A/F) of an air-fuel mixture in a combustion chamber based on the concentration of the oxygen (O₂) contained in exhaust gas so as to control an internal combustion engine is in wide use. A limiting-current gas sensor is an example of this type of air-fuel ratio sensor.

The limiting-current gas sensor used as the air-fuel ratio sensor described above is provided with a pumping cell that is an electrochemical cell which includes a solid electrolyte body having oxide ion conductivity and a pair of electrodes fixed to surfaces of the solid electrolyte body. One of the pair of electrodes is exposed to the exhaust gas from the internal combustion engine as test gas that is introduced via a diffusion resistance unit and the other one of the pair of electrodes is exposed to the atmosphere. When a voltage equal to or higher than a voltage at which the decomposition of oxygen is initiated (decomposition initiation voltage) is applied between the pair of electrodes with one of the pair of electrodes being a cathode and the other one of the pair of electrodes being an anode, the oxygen contained in the test gas becomes an oxide ion (O²⁻) through reductive decomposition. This oxide ion is conducted to the anode via the solid electrolyte body, becomes oxygen, and is discharged into the atmosphere. This oxygen movement based on the conduction of the oxide ion via the solid electrolyte body from the cathode side to the anode side is referred to as an “oxygen pumping action”.

The conduction of the oxide ion resulting from the oxygen pumping action causes a current flow between the pair of electrodes. This current that flows between the pair of electrodes is referred to as an “electrode current”. This electrode current tends to become stronger as the voltage applied between the pair of electrodes (hereinafter, simply referred to as an “applied voltage” in some cases) increases. However, the flow rate of the test gas reaching the electrode (cathode) is limited by the diffusion resistance unit, and thus the rate of consumption of the oxygen resulting from the oxygen pumping action exceeds the rate of supply of the oxygen to the cathode soon. In other words, the reductive decomposition reaction of the oxygen in the cathode reaches a diffusion rate-controlled state.

In the diffusion rate-controlled state, the electrode current does not increase but remains substantially constant despite a rise in the applied voltage. The characteristics are referred to as “limiting current characteristics” and the range of the applied voltage in which the limiting current characteristics are expressed (observed) is referred to as a “limiting current region”. The electrode current in the limiting current region is referred to as a “limiting current” and the magnitude of the limiting current (limiting current value) is correlated with the rate of the supply of the oxygen to the cathode. Since the flow rate of the test gas reaching the cathode is maintained to be constant by the diffusion resistance unit as described above, the rate of the supply of the oxygen to the cathode is correlated with the concentration of the oxygen contained in the test gas.

Accordingly, in the limiting-current gas sensor used as the air-fuel ratio sensor, the electrode current (limiting current) pertaining to a case where the applied voltage is set to the “predetermined voltage in the limiting current region” is correlated with the concentration of the oxygen contained in the test gas. By using the limiting current characteristics of the oxygen described above, the air-fuel ratio sensor can detect the concentration of the oxygen contained in the test gas and acquire the air-fuel ratio of the air-fuel mixture in the combustion chamber based thereon.

The limiting current characteristics described above are not characteristics limited to oxygen gas. Specifically, the limiting current characteristics can be expressed based on an appropriate selection of the applied voltage and a cathode configuration in some of gases containing oxygen atoms in molecules (hereinafter, referred to as “oxygen-containing gases” in some cases). Examples of the oxygen-containing gases include sulfur oxide (SOx), water (H₂O), and carbon dioxide (CO₂).

A fuel for the internal combustion engine (such as light oil and gasoline) contains a small amount of a sulfur (S) component. Especially, a fuel that is also referred to as a poor fuel may have a relatively high sulfur component content. When the sulfur component content (hereinafter, simply referred to as a “sulfur content” in some cases) of a fuel is high, the likelihood of problems increases such as the degradation and/or malfunctioning of members constituting the internal combustion engine, poisoning of an exhaust gas purification catalyst, and generation of white smoke in the exhaust gas. Accordingly, it is desirable that the sulfur component content of the fuel is acquired so that the acquired sulfur content is, for example, reflected in controlling the internal combustion engine, used in issuing a warning relating to the malfunctioning of the internal combustion engine, or utilized in improving the on-board diagnosis (OBD) of the exhaust gas purification catalyst.

When the fuel for the internal combustion engine contains the sulfur component, sulfur oxide is contained in the exhaust gas that is discharged from the combustion chamber. In addition, the concentration of the sulfur oxide contained in the exhaust gas (hereinafter, simply referred to as a “SOx concentration” in some cases) increases as the content of the sulfur component in the fuel (sulfur content) increases. Accordingly, it is considered that an accurate sulfur content can be acquired based on the acquired SOx concentration when an accurate SOx concentration in the exhaust gas can be acquired.

In this technical field, attempts have been made to acquire the concentration of sulfur oxide contained in exhaust gas from an internal combustion engine by using the limiting-current gas sensor that uses the oxygen pumping action described above. Specifically, a limiting-current gas sensor (two-cell and limiting-current gas sensor) is in use that is provided with two pumping cells which are arranged in series with cathodes facing each other in an internal space into which the exhaust gas from the internal combustion engine is introduced as test gas via the diffusion resistance unit.

In this sensor, the oxygen contained in the test gas is removed by the oxygen pumping action of the upstream-side pumping cell when a relatively low voltage is applied between the electrodes of the upstream-side pumping cell. In addition, the sulfur oxide contained in the test gas is subjected to reductive decomposition in the cathode by the downstream-side pumping cell when a relatively high voltage is applied between the electrodes of the downstream-side pumping cell, and the oxide ion that is generated as a result is conducted to the anode. The concentration of the sulfur oxide contained in the test gas is acquired based on the change in the electrode current value attributable to the oxygen pumping action (for example, refer to Japanese Patent Application Publication No. 11-190721).

### SUMMARY OF THE INVENTION

As described above, attempts have been made in this technical field to acquire the concentration of sulfur oxide contained in exhaust gas from an internal combustion engine by using the limiting-current gas sensor that uses the oxygen pumping action. However, the sulfur oxide that is contained in the exhaust gas has an extremely low level of concentration and the current (decomposition current) attributable to the decomposition of the sulfur oxide is extremely weak. In addition, decomposition currents attributable to oxygen-containing gases other than the sulfur oxide (such as water and carbon dioxide) can also flow between the electrodes. Accordingly, it is difficult to accurately distinguish and detect only the decomposition current that is attributable to the sulfur oxide.

The invention provides a gas concentration detecting device that is capable of acquiring the concentration of sulfur oxide contained in exhaust gas as test gas with the highest level of accuracy possible by using a limiting-current gas sensor.

The inventor has conducted an intensive study so as to achieve the goal described above. As a result, it has been found out that an electrode current pertaining to a case where water and sulfur oxide are decomposed at a predetermined applied voltage in an electrochemical cell (pumping cell) capable of an oxygen pumping action changes in accordance with the concentration of the sulfur oxide in exhaust gas from an internal combustion engine as test gas.

More specifically, a limiting-current gas sensor that is provided with a pumping cell is configured to be capable of water and sulfur oxide decomposition at a predetermined applied voltage. When the predetermined applied voltage is applied between the pair of electrodes of the pumping cell, a current that is attributable to the decomposition of the water and the sulfur oxide contained in the test gas flows between the electrodes. In other words, the electrode current pertaining to this case includes the decomposition current attributable to the water and the decomposition current attributable to the sulfur oxide.

In general, water in exhaust gas from an internal combustion engine has a higher concentration than sulfur oxide in the exhaust gas from the internal combustion engine, and thus the electrode current is stronger than the decomposition current that is attributable only to the sulfur oxide contained in the test gas and can be easily and accurately detected. The inventor has found out that the magnitude of this electrode current changes in accordance with the concentration of the sulfur oxide contained in the test gas. Accordingly, the inventor has reached a conclusion that the concentration of the sulfur oxide contained in the test gas can be accurately acquired based on the acquisition of a detected value correlated with the electrode current.

According to an aspect of the invention, there is provided a gas concentration detecting device including a gas concentration detecting element, a first current detector, a first electric power supply, and an electronic control unit (ECU).

The gas concentration detecting element includes a first electrochemical cell, a dense body and a diffusion resistance unit. The first electrochemical cell includes a first solid electrolyte body, a first electrode and a second electrode. The first solid electrolyte body has oxide ion conductivity. The first electrode and the second electrode are arranged on respective surfaces of the first solid electrolyte body. The first solid electrolyte body, the dense body and the diffusion resistance unit are configured to define an internal space. The diffusion resistance unit is configured to introduce exhaust gas from an internal combustion engine as test gas into the internal space via the diffusion resistance unit. The first electrode is exposed to the internal space. The second electrode is exposed to a first separate space as a space other than the internal space. The first electrode is configured to decompose water and sulfur oxide contained in the test gas when a first predetermined voltage is applied to a first electrode pair of the first electrode and the second electrode. The first current detector is configured to output a first detected value correlated with a current flowing through the first electrode pair. The first electric power supply is configured to apply a voltage to the first electrode pair. The ECU is configured to (i) control the first electric power supply (61) such that the first predetermined voltage is applied to the first electrode pair; (ii) acquire the first detected value from the first current detector (71) when the first predetermined voltage is applied to the first electrode pair; and (iii) detect the concentration of the sulfur oxide contained in the test gas based on the first detected value.

According to the gas concentration detecting device of the aspect described above, the first electrode is configured to be capable of decomposing the water (H₂O) and the sulfur oxide (SOx) contained in the test gas when the first predetermined voltage is applied between the first electrode and the second electrode. The first electrode that is capable of decomposing the water and the sulfur oxide at a predetermined applied voltage as described above can be produced by appropriately selecting, for example, the type of a substance constituting an electrode material and a heat treatment condition pertaining to the production of the electrode.

The ECU is configured to control the first electric power supply so that the first predetermined voltage is applied between the first electrode and the second electrode. The first predetermined voltage is a voltage higher than the “decomposition initiation voltage of sulfur oxide” and equal to or higher than the “decomposition initiation voltage of water”. Accordingly, when the first predetermined voltage is applied between the first electrode and the second electrode, an electrode current that is attributable to the decomposition of the water and the sulfur oxide contained in the test gas flows between the electrodes. The magnitude of this electrode current changes in accordance with the concentration of the sulfur oxide contained in the test gas as described above.

The ECU acquires the first detected value from the first current detector in a case where the first predetermined voltage is applied between the first electrode and the second electrode. The ECU is configured to detect the concentration of the sulfur oxide contained in the test gas based on the acquired first detected value after the acquisition of the first detected value. More specifically, the ECU can specify an SOx concentration correlated with the acquired first detected value based on, for example, a correspondence relationship between the concentration of the sulfur oxide contained in the test gas (SOx concentration) acquired in advance and the first detected value. In this manner, the device according to the invention can accurately detect the concentration of the sulfur oxide contained in the test gas.

The concentration of the water contained in the exhaust gas discharged from the internal combustion engine changes in accordance with, for example, the air-fuel ratio of an air-fuel mixture combusted in a combustion chamber of the internal combustion engine. When the concentration of the water contained in the exhaust gas from the internal combustion engine as the test gas changes, the accuracy of the concentration of the sulfur oxide detected based on the first detected value may be reduced. Accordingly, it is desirable that the first detected value is detected when the air-fuel ratio of the air-fuel mixture combusted in the combustion chamber of the internal combustion engine is maintained at a predetermined value, examples of which include during a steady operation of the internal combustion engine, for the concentration of the sulfur oxide contained in the test gas to be accurately detected based on the first detected value.

Details of a mechanism in which the first detected value acquired in a case where the first predetermined voltage is applied between the first electrode and the second electrode as described above changes in accordance with the concentration of the sulfur oxide in the test gas are unknown. However, not only the water contained in the test gas but also the sulfur oxide contained in the test gas is decomposed when the first predetermined voltage is applied between the first electrode and the second electrode as described above. As a result, it is considered that the decomposition product of the sulfur oxide (examples including sulfur (S) and a sulfur compound) adsorbs to the first electrode, which is a cathode, and decreases the area of the first electrode capable of contributing to the decomposition of water. Accordingly, it is considered that the first detected value, which is correlated with the electrode current pertaining to the application of the first predetermined voltage between the first electrode and the second electrode, changes in accordance with the concentration of the sulfur oxide contained in the test gas.

According to the mechanism described above, an increasing amount of the decomposition product of the sulfur oxide adsorbs to the first electrode and the rate of reduction in the electrode current correlated with the first detected value increases as the period in which the first predetermined voltage is applied between the first electrode and the second electrode extends. In other words, the rate of reduction in the electrode current correlated with the first detected value changes in accordance with the length of the period in which the first predetermined voltage is applied between the first electrode and the second electrode. Accordingly, it is desirable that the first detected value is detected at a point in time when the first predetermined voltage is applied between the first electrode and the second electrode over a predetermined period determined in advance for the concentration of the sulfur oxide contained in the test gas to be accurately detected based on the first detected value. In addition, it is desirable that the correspondence relationship between the SOx concentration and the first detected value described above is acquired by using the first detected value at a point in time when the first predetermined voltage is applied between the first electrode and the second electrode over a predetermined period determined in advance.

In addition, the decomposition product adsorbing to the first electrode needs to be removed in a case where the concentration of the sulfur oxide contained in the test gas is to be detected again by reusing this gas concentration detecting device used in detecting the concentration of the sulfur oxide contained in the test gas. A method for removing the decomposition product adsorbing to the first electrode is not particularly limited, and examples thereof can include reoxidizing the decomposition product so that the decomposition product turns back into sulfur oxide. This reoxidation can be performed by, for example, applying a predetermined voltage that allows the decomposition product to be reoxidized between the first electrode and the second electrode with the first electrode being an anode and the second electrode being a cathode (which is opposite to the case of the reductive decomposition of sulfur oxide).

When the applied voltage between the first electrode and the second electrode becomes a voltage equal to or higher than the lower limit voltage of the limiting current region of the water, the rate of decomposition of the water in the first electrode exceeds the rate of supply of the water reaching the first electrode (cathode) via the diffusion resistance unit. In other words, the limiting current characteristics of the water are expressed. In this case, it may be difficult to accurately detect the concentration of the sulfur oxide contained in the test gas based on the first detected value. In addition, when the applied voltage between the first electrode and the second electrode exceeds the limiting current region of the water and further increases, an electrode current that is attributable to the decomposition of another component contained in the test gas (such as carbon dioxide (CO₂)) may begin to flow. In addition, an excessively high applied voltage may result in the decomposition of the solid electrolyte body. In this case, the electrode current may change due to a factor other than the decomposition current attributable to the water and the sulfur oxide. As a result, it may be difficult to accurately detect the concentration of the sulfur oxide contained in the test gas based on the first detected value.

Accordingly, in the gas concentration detecting device according to the aspect described above, the first predetermined voltage may be set to a predetermined voltage lower than the lower limit voltage of the limiting current region of water. In other words, the first predetermined voltage may be set to a predetermined voltage lower than the lower limit of the voltage range in which the limiting current characteristics of water are expressed (observed). Accordingly, the ECU may be configured to control the first electric power supply so that a predetermined voltage lower than the lower limit voltage of the limiting current region of water is applied as the first predetermined voltage. Then, the likelihood of a change in the electrode current due to a factor other than the decomposition current attributable to the water and the sulfur oxide is reduced and the concentration of the sulfur oxide contained in the test gas can be more reliably and accurately detected. The lower limit voltage of the limiting current region of the water is approximately 2.0 V although slight fluctuations are seen depending on, for example, the concentration of the water contained in the test gas and measurement conditions.

In the gas concentration detecting device according to the aspect described above, the first predetermined voltage may be set to a predetermined voltage equal to or higher than the decomposition initiation voltage of water as described above. The decomposition initiation voltage of the water is approximately 0.6 V although slight fluctuations are seen depending on, for example, the concentration of the oxygen contained in the test gas and measurement conditions. Accordingly, the first predetermined voltage may be set to a predetermined voltage equal to or higher than 0.6 V. Accordingly, the ECU unit may be configured to control the first electric power supply so that a predetermined voltage of at least 0.6 V is applied as the first predetermined voltage. This allows the applied voltage between the first electrode and the second electrode to be easily set so that not only the water contained in the test gas but also the sulfur oxide contained in the test gas can be ensured to be decomposed.

As described above, this gas concentration detecting device can accurately detect the concentration of the sulfur oxide contained in the test gas based on the first detected value correlated with the electrode current which flows between the first electrode and the second electrode when the first predetermined voltage is applied between the first electrode and the second electrode. This first detected value is not particularly limited insofar as the first detected value is the value of any signal correlated with the electrode current (examples including a voltage value, a current value, and a resistance value). Typically, the first detected value may be the magnitude of the current that flows between the first electrode and the second electrode in a case where the first predetermined voltage is applied between the first electrode and the second electrode. In other words, the ECU may be configured to acquire the magnitude of the current flowing between the first electrode and the second electrode as the first detected value in a case where the first predetermined voltage is applied between the first electrode and the second electrode.

As described above, the magnitude of the electrode current that flows between the first electrode and the second electrode in a case where the first predetermined voltage is applied between the first electrode and the second electrode changes in accordance with the concentration of the sulfur oxide contained in the test gas. Specifically, the electrode current weakens as the concentration of the sulfur oxide contained in the test gas increases as described later. Accordingly, the ECU may be configured to detect a higher concentration value of the concentration of the sulfur oxide (SOx) contained in the test gas as the first detected value decreases in a case where the magnitude of the current flowing between the electrodes when the first predetermined voltage is applied between the first electrode and the second electrode as described above is the first detected value.

As described above, the first electrode is configured to be capable of decomposing the water and the sulfur oxide contained in the test gas when the first predetermined voltage is applied between the first electrode and the second electrode. The first electrode that is capable of decomposing the water and the sulfur oxide at a predetermined applied voltage as described above can be produced by appropriately selecting, for example, the type of a substance constituting an electrode material and a heat treatment condition pertaining to the production of the electrode. Examples of the material constituting the first electrode include a substance (such as a precious metal) that has activity so that the water and the sulfur oxide contained in the test gas can be decomposed when the first predetermined voltage is applied between the first electrode and the second electrode. Typically, the first electrode may contain at least one selected from the group consisting of platinum (Pt), rhodium (Rh), and palladium (Pd).

In general, the decomposition initiation voltage of the oxygen in the electrochemical cell is lower than the decomposition initiation voltage of the water. Accordingly, the electrode current that is correlated with the first detected value includes the decomposition current attributable to the oxygen as well as the decomposition current attributable to the water and the decomposition current attributable to the sulfur oxide. Accordingly, the accuracy of the concentration of the sulfur oxide detected based on the first detected value may be reduced when the concentration of the oxygen contained in the test gas changes.

In the gas concentration detecting device according to the aspect described above, the gas concentration detecting element may include a second electrochemical cell. The second electrochemical cell may include a second solid electrolyte body, a third electrode and a fourth electrode. The second solid electrolyte body may have oxide ion conductivity. The third electrode and the fourth electrode may be arranged on respective surfaces of the second solid electrolyte body. The third electrode may be exposed to the internal space. The fourth electrode may be exposed to a second separate space as a space other than the internal space. The third electrode may be arranged at a position in the internal space closer to the diffusion resistance unit than the first electrode is. The third electrode may be configured to discharge oxygen from the internal space or introduce oxygen into the internal space when a second predetermined voltage is applied to a second electrode pair of the third electrode and the fourth electrode.

A second electric power supply, which applies a voltage to the second electrode pair, may be provided. The electronic control unit may be configured to control the second electric power supply (62) such that the second predetermined voltage is applied to the second electrode pair. The electronic control unit (81) may be configured to acquire the first detected value from the first current detector (71) when the concentration of the oxygen in the internal space is adjusted to a predetermined concentration with the second predetermined voltage applied to the second electrode pair and when the first predetermined voltage is applied to the first electrode pair.

According to the gas concentration detecting device of the aspect described above, the concentration of the oxygen contained in the test gas reaching the first electrode in the internal space can be adjusted to a predetermined concentration by the oxygen pumping action of the second electrochemical cell even when the concentration of the oxygen contained in the test gas changes due to a change in the air-fuel ratio of the air-fuel mixture combusted in the combustion chamber of the internal combustion engine. As a result, the concentration of the sulfur oxide contained in the test gas can be more reliably and accurately detected.

As described above, the second predetermined voltage is a voltage that allows the discharge of the oxygen (O₂) from the internal space or the introduction of the oxygen into the internal space when the voltage is applied between the third electrode and the fourth electrode. Specifically, the second predetermined voltage is a predetermined voltage that allows the oxygen contained in the test gas to be discharged from the internal space to the second separate space by the oxygen pumping action when applied between the third electrode and the fourth electrode in a case where the third electrode is a cathode and the fourth electrode is an anode. Alternatively, the second predetermined voltage is a predetermined voltage that allows the oxygen contained in the second separate space to be introduced from the atmosphere into the internal space by the oxygen pumping action when applied between the third electrode and the fourth electrode in a case where the third electrode is an anode and the fourth electrode is a cathode (in this case, the gas that is present in the second separate space needs to contain oxygen). In other words, the second predetermined voltage may be a predetermined voltage equal to or higher than the decomposition initiation voltage of the oxygen.

The water contained in the test gas is decomposed by the second electrochemical cell when the applied voltage between the third electrode and the fourth electrode becomes equal to or higher than the decomposition initiation voltage of the water in a case where, for example, the third electrode is a cathode and the fourth electrode is an anode. In this case, the concentration of the water contained in the test gas reaching the first electrode, which is a cathode, of the first electrochemical cell on the further downstream side than the second electrochemical cell decreases. As a result, the first detected value changes, and thus it may become difficult to accurately detect the concentration of the sulfur oxide contained in the test gas based on the first detected value with this gas concentration detecting device. Accordingly, the second predetermined voltage may be a predetermined voltage lower than the decomposition initiation voltage of the water.

As described above, the second predetermined voltage may be a predetermined voltage that is equal to or higher than the decomposition initiation voltage of the oxygen and is lower than the decomposition initiation voltage of the water. Accordingly, the ECU may be configured to control the second electric power supply such that a predetermined voltage equal to or higher than the decomposition initiation voltage of the oxygen and lower than the decomposition initiation voltage of the water is applied as the second predetermined voltage. In this case, the concentration of the oxygen contained in the test gas reaching the first electrode, which is a cathode, of the first electrochemical cell can be adjusted to a predetermined concentration and a change in the concentration of the water contained in the test gas reaching the first electrode, which is a cathode, of the first electrochemical cell can be avoided. As a result, the concentration of the sulfur oxide contained in the test gas can be more reliably and accurately detected.

In the gas concentration detecting device according to the aspect described above, the gas concentration detecting element may include a third electrochemical cell. The third electrochemical cell may include a third solid electrolyte body, a fifth electrode and a sixth electrode. The third solid electrolyte body may have oxide ion conductivity. The fifth electrode and the sixth electrode may be arranged on respective surfaces of the third solid electrolyte body. The fifth electrode may be exposed to the internal space. The sixth electrode may be exposed to a third separate space as a space other than the internal space.

In this case, the fifth electrode may be configured such that a second decomposition rate as the rate of sulfur oxide decomposition by the third electrochemical cell pertaining to a case where a third predetermined voltage is applied to a third electrode pair of the fifth electrode and the sixth electrode is lower than a first decomposition rate as the rate of sulfur oxide decomposition by the first electrochemical cell pertaining to a case where the first predetermined voltage is applied to the first electrode pair. In addition, a third current detector that outputs a third detected value correlated with a current flowing through the third electrode pair may be provided. A third electric power supply, which applies a voltage to the third electrode pair, may be provided. Preferably, the second decomposition rate may be substantially 0 (zero). As described above, the activity (decomposition rate) of the electrode with respect to the decomposition of the sulfur oxide depends on various factors such as the type of a substance constituting an electrode material, a heat treatment condition pertaining to the production of the electrode, the applied voltage and an electrode temperature.

The ECU may be configured to control the third electric power supply such that the third predetermined voltage is applied between the fifth electrode and the sixth electrode. In addition, the ECU may be configured to acquire a second detected value correlated with a current flowing between the fifth electrode and the sixth electrode. The ECU may be configured to detect the concentration of the sulfur oxide contained in the test gas based on the difference between the first detected value acquired in a case where the first predetermined voltage is applied between the first electrode and the second electrode and the second detected value acquired in a case where the third predetermined voltage is applied between the fifth electrode and the sixth electrode.

As described above, the rate of sulfur oxide decomposition in the fifth electrode, which is a cathode, of the third electrochemical cell is lower than the rate of sulfur oxide decomposition in the first electrode, which is a cathode, of the first electrochemical cell (second decomposition rate<first decomposition rate). Accordingly, in a case where sulfur oxide is contained in the test gas, the rate of the adsorption of the decomposition product of the sulfur oxide is lower in the fifth electrode than in the first electrode, and thus the area of the electrode that is capable of contributing to the decomposition of water is larger in the fifth electrode than in the first electrode. As a result, the difference between the first detected value and the second detected value changes in accordance with the concentration of the sulfur oxide contained in the test gas. In other words, the concentration of the sulfur oxide contained in the test gas can be accurately detected based on the difference between the first detected value and the second detected value and the difference between the first decomposition rate and the second decomposition rate.

In a case where, for example, the rate of sulfur oxide decomposition in the fifth electrode (second decomposition rate) is substantially 0 (zero), no substantial adsorption of the decomposition product of the sulfur oxide occurs in the fifth electrode, and thus the concentration of the water contained in the test gas can be detected based on the second detected value acquired from the third electrochemical cell. In this case, the concentration of the sulfur oxide contained in the test gas can be more simply and accurately detected based on the difference between the first detected value and the second detected value.

As described above, the second detected value correlated with the electrode current including the decomposition current attributable to the water is acquired also in the third electrochemical cell. Accordingly, the third predetermined voltage may be a predetermined voltage equal to or higher than the decomposition initiation voltage of the water and lower than the lower limit voltage of the limiting current region of the water as is the case with the first predetermined voltage. Accordingly, the ECU may be configured to control the third electric power supply such that a predetermined voltage equal to or higher than the decomposition initiation voltage of the water and lower than the lower limit voltage of the limiting current region of the water is applied as the third predetermined voltage. In this manner, the water contained in the test gas can be reliably decomposed even in the fifth electrode.

In order for the concentration of the sulfur oxide contained in the test gas to be accurately detected based on the difference between the first detected value and the second detected value as described above, the first detected value and the second detected value may be acquired under the same conditions if possible with the only exception that the sulfur oxide decomposition rates in the respective cathodes differ from each other. For example, the third predetermined voltage may be equal to the first predetermined voltage. Accordingly, the ECU may be configured to apply the voltage equal to the first predetermined voltage as the third predetermined voltage.

When the concentration of the sulfur oxide contained in the test gas is calculated from the difference between the first detected value and the second detected value as described above, the applied voltage difference between the first electrochemical cell and the third electrochemical cell does not have to be taken into account, and thus a calculation load can be reduced. In addition, since the third predetermined voltage is equal to the first predetermined voltage, the electric power supply for the application of the applied voltage to the respective electrodes can be allowed to be shared by the first electrochemical cell and the third electrochemical cell. As a result, the gas concentration detecting device according to the invention can be reduced in manufacturing cost and/or in size and weight.

In order for the concentration of the sulfur oxide contained in the test gas to be accurately detected based on the difference between the first detected value and the second detected value as described above, it is desirable that the test gas reaching the first electrode of the first electrochemical cell and the test gas reaching the fifth electrode of the third electrochemical cell have the same composition. Accordingly, the fifth electrode may be formed in a region reached by test gas containing water with the concentration equal to the concentration of the water contained in the test gas reaching the first electrode. Typically, the fifth electrode may be formed in the vicinity of the first electrode in this case.

When the concentration of the sulfur oxide contained in the test gas is calculated from the difference between the first detected value and the second detected value as described above, the test gas composition difference between the first electrochemical cell and the third electrochemical cell does not have to be taken into account, and thus a calculation load can be reduced.

The second detected value is not particularly limited, as is the case with the first detected value, insofar as the second detected value is the value of any signal (examples including a voltage value, a current value, and a resistance value) correlated with the current flowing between the fifth electrode and the sixth electrode when the third predetermined voltage is applied between the fifth electrode and the sixth electrode. Typically, the second detected value may be the magnitude of the current that flows between the fifth electrode and the sixth electrode in a case where the third predetermined voltage is applied between the fifth electrode and the sixth electrode. In this case, the ECU may be configured to acquire the magnitude of the current that flows between the fifth electrode and the sixth electrode as the second detected value in a case where the third predetermined voltage is applied between the fifth electrode and the sixth electrode.

As described above, the second decomposition rate is lower than the first decomposition rate, and the difference between the first detected value and the second detected value that is acquired as a result thereof changes in accordance with the concentration of the sulfur oxide contained in the test gas. Specifically, the difference between the first detected value and the second detected value increases as the concentration of the sulfur oxide contained in the test gas increases. Accordingly, the ECU may be configured to detect a higher value of the concentration of the sulfur oxide (SOx) contained in the test gas as the absolute value of the difference between the first detected value and the second detected value increases in a case where the magnitude of the current that flows between the fifth electrode and the sixth electrode pertaining to a case where the third predetermined voltage is applied between the fifth electrode and the sixth electrode is the second detected value as described above.

As described above, the fifth electrode is configured to be capable of decomposing at least the water contained in the test gas when the third predetermined voltage is applied between the fifth electrode and the sixth electrode. The fifth electrode that is capable of decomposing the water at a predetermined applied voltage as described above can be produced by appropriately selecting, for example, the type of a substance constituting an electrode material and a heat treatment condition pertaining to the production of the electrode. Typically, the fifth electrode may contain at least one selected from the group consisting of platinum (Pt), gold (Au), lead (Pb), and silver (Ag).

As described in the beginning of this specification, an air-fuel ratio sensor that acquires the air-fuel ratio of an air-fuel mixture combusted in a combustion chamber of an internal combustion engine based on the concentration of the oxygen contained in exhaust gas so as to control the internal combustion engine is in wide use. A limiting-current gas sensor is an example of this type of air-fuel ratio sensor. Accordingly, the device according to the invention can be used as the air-fuel ratio sensor insofar as the limiting current value of oxygen can be detected by using this gas concentration detecting device.

Specifically, an applied voltage correlated with the limiting current region of oxygen may be set in any one or more of the first electrochemical cell, the second electrochemical cell (in a case where the gas concentration detecting element is provided with the second electrochemical cell), and the third electrochemical cell (in a case where the gas concentration detecting element is provided with the third electrochemical cell) described above. The concentration of the oxygen contained in the exhaust gas from the internal combustion engine as the test gas may be detected based on the detected value correlated with the electrode current pertaining to this case. The air-fuel ratio of the air-fuel mixture in the combustion chamber of the internal combustion engine correlated with the test gas may be detected based on the concentration of the oxygen in the exhaust gas detected in this manner.

More Specifically, the ECU may be configured to apply a fourth predetermined voltage, which is a predetermined voltage lower than the decomposition initiation voltage of water, to at least one of the first electrode pair of the first electrode and the second electrode, the second electrode pair of the third electrode and the fourth electrode, and the third electrode pair of the fifth electrode and the sixth electrode in a case where the gas concentration detecting element is provided with all of the first electrochemical cell, the second electrochemical cell and the third electrochemical cell. In other words, the applied voltage correlated with the limiting current region of oxygen may be applied in at least any one of the first electrochemical cell, the second electrochemical cell, and the third electrochemical cell.

In this case, the ECU may be configured to detect the air-fuel ratio (A/F) of the air-fuel mixture in the combustion chamber of the internal combustion engine correlated with the test gas based on a detected value correlated with a current flowing through the first electrode pair, the second electrode pair, and/or the third electrode pair to which the fourth predetermined voltage is applied.

The ECU may be configured to apply the fourth predetermined voltage, which is a predetermined voltage lower than the decomposition initiation voltage of water, to at least one of the first electrode pair of the first electrode and the second electrode and the second electrode pair of the third electrode and the fourth electrode in a case where the gas concentration detecting element is provided with the first electrochemical cell and the second electrochemical cell described above and is not provided with the third electrochemical cell. In other words, the applied voltage correlated with the limiting current region of oxygen may be applied in at least any one of the first electrochemical cell and the second electrochemical cell. In this case, the ECU may be configured to detect the air-fuel ratio (A/F) of the air-fuel mixture in the combustion chamber of the internal combustion engine correlated with the test gas based on a detected value correlated with a current flowing through the first electrode pair and/or the second electrode pair to which the fourth predetermined voltage is applied.

The ECU may be configured to apply the fourth predetermined voltage, which is a predetermined voltage lower than the decomposition initiation voltage of water, to the first electrode pair of the first electrode and the second electrode in a case where the gas concentration detecting element is provided with the first electrochemical cell described above and is not provided with the second electrochemical cell and the third electrochemical cell. In other words, the applied voltage correlated with the limiting current region of oxygen may be applied in the first electrochemical cell. In this case, the ECU may be configured to detect the air-fuel ratio (A/F) of the air-fuel mixture in the combustion chamber of the internal combustion engine correlated with the test gas based on a detected value correlated with a current flowing through the first electrode pair to which the fourth predetermined voltage is applied.

In any of the cases described above, a correspondence relationship between the detected value (such as the magnitude of the electrode current) and the air-fuel ratio of the air-fuel mixture in the combustion chamber correlated with the test gas pertaining to a case where, for example, the applied voltage is a predetermined voltage lower than the decomposition initiation voltage of the water is obtained in a prior experiment or the like. A data table (such as a data map) showing the correspondence relationship can be stored in a data storage device (such as a ROM) of the ECU so that a CPU can refer to the data table during the detection. In this manner, the air-fuel ratio of the air-fuel mixture can be specified from the detected value. Alternatively, the air-fuel ratio of the air-fuel mixture may be specified from the concentration of the oxygen in the test gas with the concentration of the oxygen in the test gas temporarily acquired from the detected value and the CPU referring to the correspondence relationship between the concentration of the oxygen in the test gas and the air-fuel ratio of the air-fuel mixture.

The other objects, features, and additional advantages of the invention will become apparent in the following description of each embodiment of the invention based on accompanying drawings.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic sectional view illustrating an example of the configuration of a gas concentration detecting element of a gas concentration detecting device (first device) according to a first embodiment of the invention;

FIG. 2 is a schematic graph illustrating a relationship between a voltage (applied voltage) Vm that is applied between a first electrode and a second electrode which constitute a first electrochemical cell of the first device and an electrode current Im that flows between the electrodes;

FIG. 3 is a schematic graph illustrating a relationship between the magnitude of the electrode current Im and the concentration of sulfur dioxide (SO₂) contained in test gas pertaining to a case where the applied voltage Vm is 1.0 V in the first device;

FIG. 4 is a flowchart illustrating the “SOx concentration acquisition processing routine” that is executed by an acquisition unit of the first device;

FIG. 5 is a schematic sectional view illustrating an example of the configuration of a gas concentration detecting element of a gas concentration detecting device (second device) according to a second embodiment of the invention;

FIG. 6A is a schematic sectional view illustrating an example of the configuration of a gas concentration detecting element of a gas concentration detecting device (third device) according to a third embodiment of the invention; and

FIG. 6B is a schematic sectional view, taken along line 6B-6B in FIG. 6A, illustrating the example of the configuration of the gas concentration detecting element of the gas concentration detecting device (third device) according to the third embodiment of the invention.

### DETAILED DESCRIPTION OF EMBODIMENTS

Hereinafter, a gas concentration detecting device according to a first embodiment of the invention (hereinafter, referred to as a “first device” in some cases) will be described with reference to accompanying drawings.

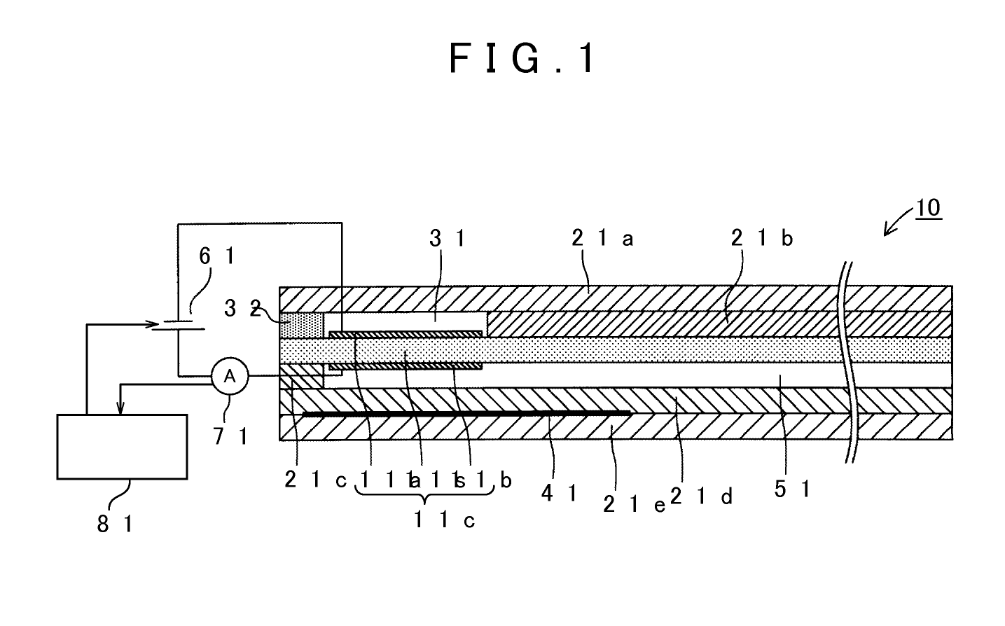

As illustrated in FIG. 1, a gas concentration detecting element 10 of the first device is provided with a solid electrolyte body 11s, a first alumina layer 21a, a second alumina layer 21b, a third alumina layer 21c, a fourth alumina layer 21d, a fifth alumina layer 21e, a diffusion resistance unit (diffusion rate controlling layer) 32, and a heater 41. The solid electrolyte body 11s is a sheet body that contains zirconia or the like and has oxide ion conductivity. The zirconia that forms the solid electrolyte body 11s may contain an element such as scandium (Sc) and yttrium (Y). The first to fifth alumina layers 21a to 21e are alumina-containing dense (gas-impermeable) layers (dense bodies). The diffusion resistance unit 32, which is a porous diffusion rate controlling layer, is a gas-permeable layer (sheet body). The heater 41 is a sheet body formed of cermet of, for example, platinum (Pt) and ceramics (such as alumina) The heater 41 is a heating element that generates heat when energized.

The respective layers of the gas concentration detecting element 10 are stacked in the order of the fifth alumina layer 21e, the fourth alumina layer 21d, the third alumina layer 21c, the solid electrolyte body 11s, the diffusion resistance unit 32 and the second alumina layer 21b, and the first alumina layer 21a from below.

An internal space 31 is a space that is formed by the first alumina layer 21a, the solid electrolyte body 11s, the diffusion resistance unit 32, and the second alumina layer 21b. Exhaust gas from an internal combustion engine is introduced, as test gas, into the internal space 31 via the diffusion resistance unit 32. In other words, the internal space 31 communicates with an inner portion of an exhaust pipe of the internal combustion engine (none of which is illustrated herein) via the diffusion resistance unit 32 in the gas concentration detecting element 10. Accordingly, the exhaust gas in the exhaust pipe is introduced into the internal space 31 as the test gas. A first atmospheric air introduction path 51 is formed by the solid electrolyte body 11s, the third alumina layer 21c, and the fourth alumina layer 21d and is open toward the atmosphere outside the exhaust pipe. The first atmospheric air introduction path 51 corresponds to a first separate space.

A first electrode 11a is a cathode and a second electrode 11b is an anode. The first electrode 11a is fixed to a surface on one side of the solid electrolyte body 11s (specifically, a surface of the solid electrolyte body 11s that defines the internal space 31). The second electrode 11b is fixed to a surface on the other side of the solid electrolyte body 11s (specifically, a surface of the solid electrolyte body 11s that defines the first atmospheric air introduction path 51). The first electrode 11a, the second electrode 11b, and the solid electrolyte body 11s constitute a first electrochemical cell 11c that is capable of oxygen pumping action-based oxygen discharge. The first electrochemical cell 11c is heated to an activation temperature by the heater 41.

The solid electrolyte body 11s and each of the first to fifth alumina layers 21a to 21e can be molded into a sheet shape by a doctor blade method, an extrusion molding method, or the like. The first electrode 11a, the second electrode 11b, and wiring or the like for the energization of the electrodes can be formed by a screen printing method or the like. When the sheets are stacked as described above and fired, the gas concentration detecting element 10 that has the above-described structure can be integrally produced. In the first device, the first electrode 11a is a porous cermet electrode that contains an alloy of platinum (Pt) and rhodium (Rh) as a main component and the second electrode 11b is a porous cermet electrode that contains platinum (Pt) as a main component.

The first device is also provided with an electric power supply 61, an ammeter 71, and an ECU 81 (electronic control unit). The electric power supply 61 and the ammeter 71 are connected to the ECU 81. The electric power supply 61 can apply a predetermined voltage between the first electrode 11a and the second electrode 11b so that the potential of the second electrode 11b exceeds the potential of the first electrode 11a. The operation of the electric power supply 61 is controlled by the ECU 81. The ammeter 71 measures the magnitude of an electrode current that is a current flowing between the first electrode 11a and the second electrode 11b (that is, a current flowing through the solid electrolyte body 11s). The ammeter 71 outputs the measured value to the ECU 81.

The ECU 81 is configured as a microcomputer including a CPU, a ROM that stores a program, a map, and the like executed by the CPU, a RAM that temporarily stores data, and the like. The ECU 81 can control an applied voltage Vm, which is applied to the first electrode 11a and the second electrode 11b, by controlling the electric power supply 61. In addition, the ECU 81 can receive a signal correlated with an electrode current Im output from the ammeter 71 and flowing through the first electrochemical cell (sensor cell) 11c. The ECU 81 may be connected to actuators (not illustrated, examples including a fuel injection valve, a throttle valve, and an EGR valve) of the internal combustion engine. In this case, the ECU 81 sends driving (instruction) signals to the actuators and also controls the internal combustion engine.

When a first predetermined voltage is applied between the first electrode 11a and the second electrode 11b so that the potential of the second electrode 11b exceeds the potential of the first electrode 11a, not only the water contained in the test gas but also the sulfur oxide contained in the test gas is decomposed in the first electrode 11a. It is considered that the decomposition product of the sulfur oxide (examples including sulfur and a sulfur compound) adsorbs to the first electrode 11a and decreases the area of the first electrode 11a capable of contributing to the decomposition of water. As a result, a first detected value, which is correlated with the electrode current pertaining to the application of the first predetermined voltage between the first electrode 11a and the second electrode 11b, changes in accordance with the concentration of the sulfur oxide contained in the test gas. Accordingly, the first device can accurately detect the concentration of the sulfur oxide contained in the test gas based on the first detected value.

As described above, the first electrochemical cell 11c is used as a sensor that acquires the concentration of the sulfur oxide contained in the test gas in this embodiment. Accordingly, the first electrochemical cell 11c will be referred to as a “sensor cell” in some cases. In other words, the first electrode 11a, the second electrode 11b, and the solid electrolyte body 11s constitute the sensor cell 11c.

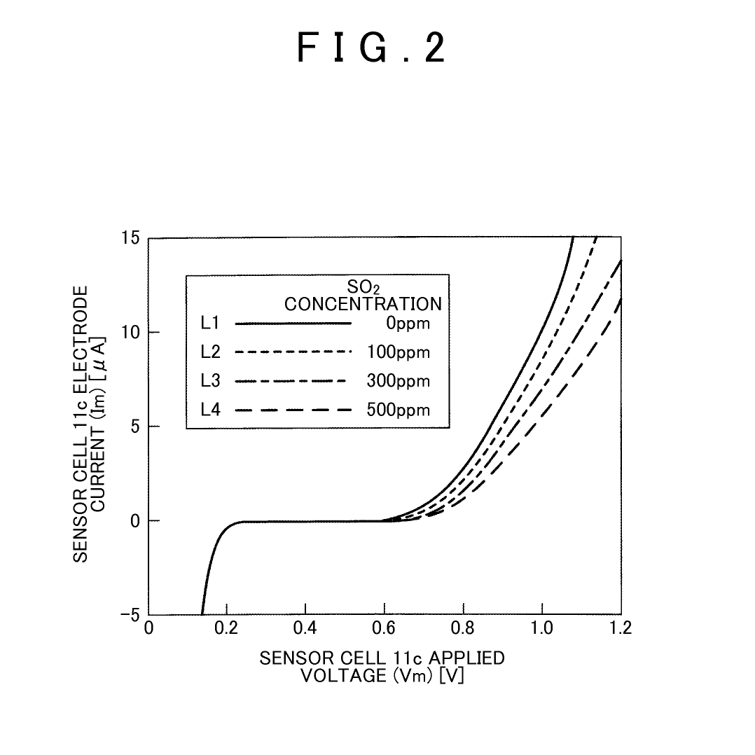

A relationship between the applied voltage Vm and the electrode current Im will be described in further detail. FIG. 2 is a schematic graph illustrating the relationship between the applied voltage Vm and the electrode current Im pertaining to a case where the applied voltage Vm is gradually raised (boost-swept) in the sensor cell 11c (one-cell and limiting-current gas sensor of the first device). In this example, four different types of test gases are used, in which the concentrations of the sulfur dioxides (SO₂) as sulfur oxides contained in the test gases are 0 ppm, 100 ppm, 300 ppm, and 500 ppm. The concentrations of the oxygen and the water contained in the test gas are maintained to be constant in each of the test gases. In this example, the limiting current value of the oxygen is expressed as 0 (zero) μA.

The solid-line curve L1 shows the relationship between the applied voltage Vm and the electrode current Im pertaining to a case where the sulfur dioxide contained in the test gas has a concentration of 0 (zero) ppm. In a region where the applied voltage Vm is lower than approximately 0.2 V, the electrode current Im increases as the applied voltage Vm increases. In this region, the rate of the decomposition of the oxygen in the first electrode 11a (cathode) increases as a result of an increase in the applied voltage Vm. In a region where the applied voltage Vm is equal to or higher than approximately 0.2 V, however, the electrode current Im is almost constant and rarely increases even when the applied voltage Vm increases. In other words, the limiting current characteristics of the oxygen described above are expressed. Then, the electrode current Im begins to increase again when the applied voltage Vm becomes equal to or higher than approximately 0.6 V. This increase in the electrode current Im is attributable to the beginning of the decomposition of the water in the first electrode 11a.

The dotted-line curve L2 shows the relationship between the applied voltage Vm and the electrode current Im pertaining to a case where the sulfur dioxide contained in the test gas has a concentration of 100 ppm. The relationship between the applied voltage Vm and the electrode current Im pertaining to this case is similar to that shown by the curve L1 (case where the sulfur dioxide contained in the test gas has a concentration of 0 (zero) ppm) when the applied voltage Vm is lower than the voltage at which the decomposition of water begins in the first electrode 11a (decomposition initiation voltage) (approximately 0.6 V). When the applied voltage Vm is equal to or higher than the decomposition initiation voltage (approximately 0.6 V) of the water in the first electrode 11a, however, the electrode current Im is exceeded by that of the curve L1 and the rate of increase in the electrode current Im with respect to the applied voltage Vm is also exceeded by that of the curve L1 (gentler slope).

The curve L3 that is shown by the one-dot chain line shows the relationship between the applied voltage Vm and the electrode current Im pertaining to a case where the sulfur dioxide contained in the test gas has a concentration of 300 ppm. The dashed-line curve L4 shows the relationship between the applied voltage Vm and the electrode current Im pertaining to a case where the sulfur dioxide contained in the test gas has a concentration of 500 ppm. In both cases, the relationship between the applied voltage Vm and the electrode current Im is similar to that shown by the curve L1 (case where the sulfur dioxide contained in the test gas has a concentration of 0 (zero) ppm) when the applied voltage Vm is lower than the decomposition initiation voltage (approximately 0.6 V) of the water in the first electrode 11a. When the applied voltage Vm is equal to or higher than the decomposition initiation voltage (approximately 0.6 V) of the water in the first electrode 11a, however, the electrode current Im decreases as the concentration of the sulfur dioxide contained in the test gas increases and the rate of increase in the electrode current Im with respect to the applied voltage Vm decreases as the concentration of the sulfur dioxide contained in the test gas increases (gentler slope).

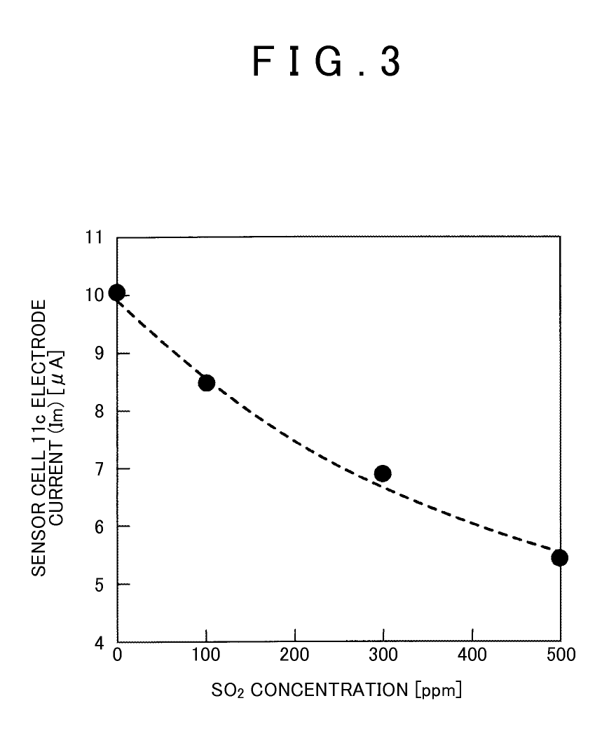

As described above, the magnitude of the electrode current Im pertaining to a case where the applied voltage Vm is equal to or higher than the decomposition initiation voltage (approximately 0.6 V) of the water in the first electrode 11a changes in accordance with the concentration of the sulfur dioxide as the sulfur oxide contained in the test gas. The graph that is illustrated in FIG. 3 is obtained when, for example, the magnitude of the electrode current Im according to the curves L1 to L4 pertaining to a case where the applied voltage Vm is 1.0 V in the graph illustrated in FIG. 2 is plotted with respect to the concentration of the sulfur dioxide contained in the test gas. As shown by the dotted-line curve in FIG. 3, the magnitude of the electrode current Im at a specific applied voltage Vm (1.0 V in this case) changes in accordance with the concentration of the sulfur dioxide contained in the test gas. Accordingly, when (the first detected value correlated with) the electrode current Im at a specific applied voltage Vm (which is a predetermined voltage equal to or higher than the decomposition initiation voltage of the water and is also referred to as the “first predetermined voltage”) is acquired, the concentration of the sulfur oxide correlated with the electrode current Im (correlated with the first detected value) can be acquired.

The respective specific values of the applied voltage Vm shown on the horizontal axis of the graph illustrated in FIG. 2, the electrode current Im shown on the vertical axis of the graph illustrated in FIG. 2, and the applied voltage Vm described above may change in accordance with the conditions (examples including the concentrations of various components contained in the test gas) of an experiment performed so as to obtain the graph illustrated in FIG. 2, and the values of the applied voltage Vm and the electrode current Im are not always limited to the values described above.

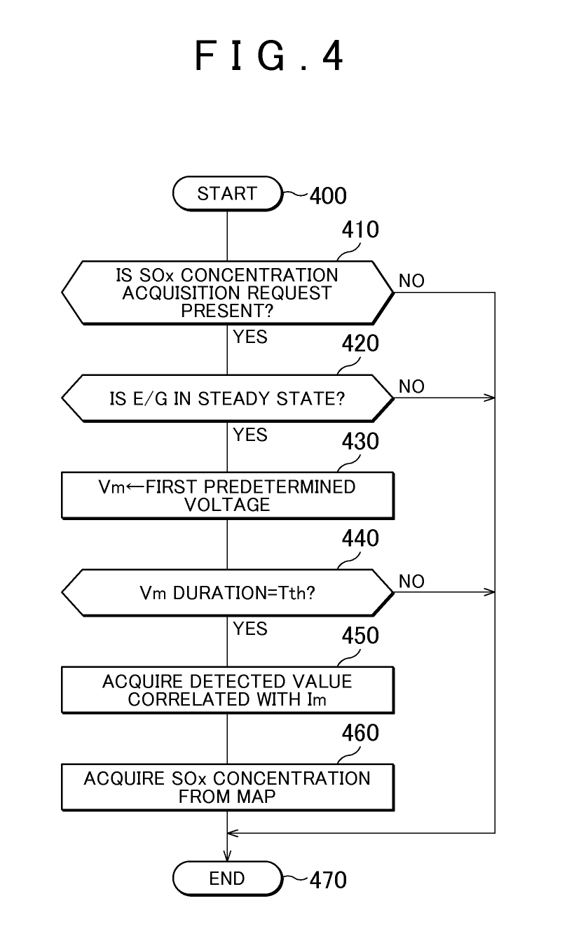

The SOx concentration acquisition processing routine that is executed in the first device will be described in further detail. FIG. 4 is a flowchart illustrating the “SOx concentration acquisition processing routine” that the ECU 81 executes by using the gas concentration detecting element 10. For example, the CPU of the ECU 81 described above (hereinafter, simply referred to as the “CPU” in some cases) initiates the processing at a predetermined timing and allows the processing to proceed from Step 400 to Step 410.

Firstly, in Step 410, the CPU determines whether or not a request for the acquisition of the concentration of the sulfur oxide contained in the test gas (SOx concentration acquisition request) is present. The SOx concentration acquisition request is generated when, for example, a fuel tank is filled with fuel in a vehicle on which the internal combustion engine to which the first device is applied is mounted. The SOx concentration acquisition request may be released in a case where the SOx concentration acquisition processing routine is executed after the fuel tank is filled with the fuel and a history of the acquisition of the concentration of the sulfur oxide contained in the test gas is present.

In a case where it is determined in Step 410 that the SOx concentration acquisition request is present (Step 410: Yes), the CPU allows the processing to proceed to Step 420 and determines whether or not the internal combustion engine (E/G) to which the first device is applied is in a steady state. The CPU determines that the internal combustion engine is in the steady state when, for example, the difference between the maximum value and the minimum value of a load within a predetermined period of time is exceeded by a threshold or when the difference between the maximum value and the minimum value of an accelerator operation amount within a predetermined period of time is exceeded by a threshold.

In a case where it is determined in Step 420 that the internal combustion engine is in the steady state (Step 420: Yes), the CPU allows the processing to proceed to Step 430 and applies the applied voltage Vm as the first predetermined voltage (1.0 V in the first device) between the first electrode 11a and the second electrode 11b. Then, the CPU allows the processing to proceed to Step 440 and determines whether or not the duration of the period when the applied voltage Vm as the first predetermined voltage is applied corresponds to a predetermined threshold (Tth). This threshold Tth corresponds to the length of a period that is sufficient for the decomposition product to adsorb to the first electrode 11a, which is a cathode, and reduce the electrode current with the sulfur oxide contained in the test gas decomposed by the applied voltage Vm between the first electrode 11a and the second electrode 11b becoming the first predetermined voltage. A specific value of the threshold Tth (length of time) can be determined based on, for example, a prior experiment in which the gas concentration detecting element 10 of the first device is used.

In a case where it is determined in Step 440 that the duration of the period when the applied voltage Vm is the first predetermined voltage corresponds to the predetermined threshold (Step 440: Yes), the CPU allows the processing to proceed to Step 450 and acquires the electrode current Im as the first detected value. Then, the CPU allows the processing to proceed to Step 460 and acquires the concentration of the sulfur oxide correlated with the first detected value by, for example, referring to the data map that is illustrated in FIG. 3. Then, the CPU allows the processing to proceed to Step 470 and terminates the routine. In this manner, the first device can accurately detect the concentration of the sulfur oxide contained in the test gas.

In a case where it is determined in Step 410 that the SOx concentration acquisition request is absent (Step 410: No), in a case where it is determined in Step 420 that the internal combustion engine is not in the steady state (Step 420: No), or in a case where it is determined in Step 440 that the duration of the period when the applied voltage Vm is the first predetermined voltage does not correspond to the predetermined threshold (Step 440: No), the CPU allows the processing to proceed to Step 470 and terminates the routine.

A program that allows the routine described above to be executed by the CPU can be stored in a data storage device (such as the ROM) of the ECU 81. In addition, a correspondence relationship between the electrode current Im as the first detected value and the concentration of the sulfur oxide contained in the test gas pertaining to a case where the applied voltage Vm is the first predetermined voltage (1.0 V in the first device) can be obtained in advance in, for example, a prior experiment using test gas with a known sulfur oxide concentration. A data table (such as a data map) showing the correspondence relationship can be stored in the data storage device (such as the ROM) of the ECU 81 so that the CPU can refer to the data table in Step 460.

In the first device, the first predetermined voltage is 1.0 V as described above. However, the first predetermined voltage is not particularly limited insofar as the first predetermined voltage is a predetermined voltage that allows the decomposition of the water and the sulfur oxide contained in the test gas when applied between the first electrode 11a and the second electrode 11b in a case where the first electrode 11a is a cathode and the second electrode 11b is an anode as described above. The decomposition initiation voltage of the water is approximately 0.6 V as described above. Accordingly, it is desirable that the first predetermined voltage is a predetermined voltage equal to or higher than 0.6 V.

As described above, the decomposition of another component contained in the test gas (such as carbon dioxide (CO₂)) and/or the solid electrolyte body 11s may occur when the applied voltage Vm is excessively high. Accordingly, it is desirable that the first predetermined voltage is a predetermined voltage exceeded by the lower limit voltage of the limiting current region of the water. In other words, it is desirable that the first predetermined voltage is a predetermined voltage equal to or higher than the decomposition initiation voltage of the water and lower than the lower limit of the voltage range in which the limiting current characteristics of the water are expressed (observed).

In the first device, the magnitude of the electrode current flowing between the first electrode 11a and the second electrode 11b when the first predetermined voltage is applied between the first electrode 11a and the second electrode 11b is the first detected value. However, the first detected value is not particularly limited insofar as the first detected value is the value of any signal correlated with the electrode current (examples including a voltage value, a current value, and a resistance value) as described above. In a case where the value of a signal that has a positive correlation with the electrode current (such as a voltage value and a current value) is adopted as the first detected value, the first device is configured to detect a higher SOx concentration value as the first detected value decreases. In a case where the value of a signal that has a negative correlation with the electrode current is adopted as the first detected value, the first device is configured to detect a higher SOx concentration value as the first detected value increases.

In the first device, the first electrode 11a is a porous cermet electrode that contains an alloy of platinum (Pt) and rhodium (Rh) as a main component and the second electrode 11b is a porous cermet electrode that contains platinum (Pt) as a main component. However, the material that constitutes the first electrode 11a is not particularly limited insofar as reductive decomposition can be performed on the water and the sulfur oxide contained in the test gas introduced into the internal space 31 via the diffusion resistance unit 32 when a first predetermined voltage is applied between the first electrode 11a and the second electrode 11b. Preferably, the material that constitutes the first electrode 11a contains, as a main component, a platinum group element such as platinum (Pt), rhodium (Rh), and palladium (Pd) or an alloy thereof More preferably, the first electrode 11a is a porous cermet electrode that contains, as a main component, at least one selected from the group consisting of platinum (Pt), rhodium (Rh), and palladium (Pd).

Hereinafter, a gas concentration detecting device according to a second embodiment of the invention (hereinafter, referred to as a “second device” in some cases) will be described.

A gas concentration detecting element 20 of the second device is similar in configuration to the gas concentration detecting element 10 of the first device with the only exception that a second electrochemical cell (pumping cell 12c), which is arranged on the upstream side (diffusion resistance unit 32 side) of the first electrochemical cell (pumping cell 11c), is further provided. The following description of the configuration of the second device will focus on how the second device differs from the first device.

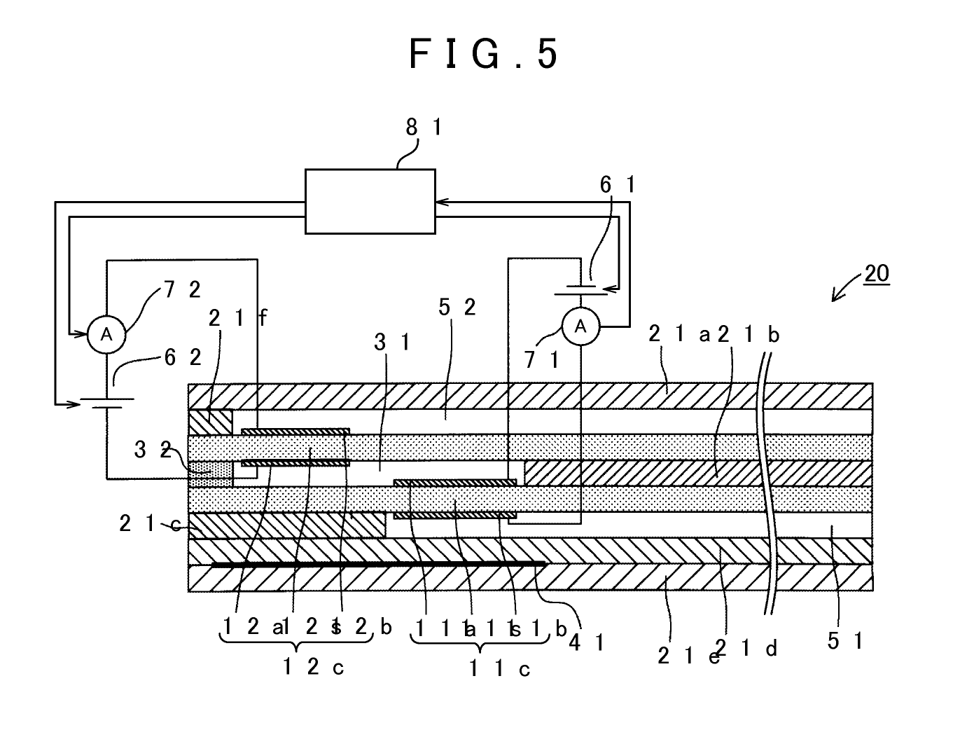

As illustrated in FIG. 5, a second solid electrolyte body 12s is arranged in place of the first alumina layer 21a of the gas concentration detecting element 10 illustrated in FIG. 1, and a sixth alumina layer 21f and the first alumina layer 21a that are stacked on the second solid electrolyte body 12s (side opposite to the internal space 31) define a second atmospheric air introduction path 52. The second atmospheric air introduction path 52 corresponds to a second separate space. The second solid electrolyte body 12s is also a sheet body that contains zirconia or the like and has oxide ion conductivity. The zirconia that forms the second solid electrolyte body 12s may contain an element such as scandium (Sc) and yttrium (Y). The sixth alumina layer 21f is an alumina-containing dense (gas-impermeable) layer (sheet body).

A third electrode 12a is fixed to a surface on one side of the second solid electrolyte body 12s (specifically, a surface of the second solid electrolyte body 12s that defines the internal space 31). A fourth electrode 12b is fixed to a surface on the other side of the second solid electrolyte body 12s (specifically, a surface of the second solid electrolyte body 12s that defines the second atmospheric air introduction path 52).

The third electrode 12a, the fourth electrode 12b, and the second solid electrolyte body 12s constitute the second electrochemical cell (pumping cell) 12c that is capable of oxygen pumping action-based oxygen discharge. The second electrochemical cell (pumping cell) 12c is arranged on the upstream side (diffusion resistance unit 32 side) of the first electrochemical cell (pumping cell 11c). More specifically, the third electrode 12a is arranged to face the internal space 31 at a position closer to the diffusion resistance unit 32 than the first electrode 11a is. The third electrode 12a and the fourth electrode 12b are porous cermet electrodes that contain platinum (Pt) as a main component.

An electric power supply 62 applies an applied voltage between the third electrode 12a and the fourth electrode 12b so that the potential of any one of the third electrode 12a and the fourth electrode 12b exceeds the potential of the other one of the third electrode 12a and the fourth electrode 12b. An ammeter 72 outputs, to the ECU 81, a signal correlated with an electrode current flowing through the second electrochemical cell 12c. The ECU 81 can control the applied voltage that is applied to the third electrode 12a and the fourth electrode 12b by controlling the electric power supply 62. In addition, the ECU 81 can receive a signal correlated with the electrode current output from the ammeter 72 and flowing through the second electrochemical cell 12c.

The concentration of the oxygen contained in the exhaust gas discharged from the internal combustion engine changes in various ways depending on, for example, the air-fuel ratio of an air-fuel mixture combusted in a combustion chamber of the internal combustion engine. As a result, the concentration of the oxygen contained in the test gas changes in some cases. When the concentration of the oxygen contained in the test gas changes, the magnitude of the current flowing between the electrodes of the sensor cell also changes, and thus the accuracy of the detection of the concentration of a component whose concentration is to be measured (examples including water and sulfur oxide) may be reduced.

According to the gas concentration detecting element 20 of the second device, however, oxygen can be discharged from the internal space 31 or oxygen can be introduced into the internal space 31 based on the oxygen pumping action when a predetermined voltage is applied between the third electrode 12a and the fourth electrode 12b. More specifically, oxygen is discharged from the internal space 31 to the second atmospheric air introduction path 52 when the voltage is applied between the third electrode 12a and the fourth electrode 12b so that the third electrode 12a becomes a cathode and the fourth electrode 12b becomes an anode. Oxygen is introduced into the internal space 31 from the second atmospheric air introduction path 52 when the voltage is applied between the third electrode 12a and the fourth electrode 12b so that the third electrode 12a becomes an anode and the fourth electrode 12b becomes a cathode. In this manner, the second electrochemical cell (pumping cell) 12c can adjust the concentration of the oxygen in the internal space 31 in the gas concentration detecting element 20 of the second device.

In other words, according to the gas concentration detecting element 20 of the second device, oxygen can be discharged from the internal space 31 based on the oxygen pumping action of the second electrochemical cell (pumping cell) 12c as described above, and thus the concentration of the oxygen in the internal space 31 can be adjusted to be reduced (typically, to approximately 0 (zero) ppm) even when the concentration of the oxygen contained in the test gas changes. Accordingly, in the second device, the effect on the electrode current Im detected in the first electrochemical cell (pumping cell) 11c can be effectively reduced even when the concentration of the oxygen contained in the test gas changes. As a result, the concentration of the sulfur oxide contained in the test gas can be accurately detected with the second device.

In the example that is illustrated in FIG. 5, the second electrochemical cell (pumping cell 12c) includes the second solid electrolyte body 12s, which is separate from the solid electrolyte body 11s that constitutes the first electrochemical cell (pumping cell 11c). However, the second electrochemical cell (pumping cell 12c) may share the solid electrolyte body 11s with the first electrochemical cell (pumping cell 11c). In this case, the first atmospheric air introduction path 51 functions as the first separate space and the second separate space.

In the example illustrated above, the first detected value (electrode current Im) in the first electrochemical cell 11c is detected after the concentration of the oxygen in the internal space 31 is adjusted to be reduced with the oxygen discharged from the internal space 31 based on the oxygen pumping action of the second electrochemical cell 12c. However, the first detected value in the first electrochemical cell 11c may also be detected after the concentration of the oxygen in the internal space 31 is adjusted to a predetermined concentration with the oxygen introduced into the internal space 31 based on the oxygen pumping action of the second electrochemical cell 12c.

Hereinafter, a gas concentration detecting device according to a third embodiment of the invention (hereinafter, referred to as a “third device” in some cases) will be described.

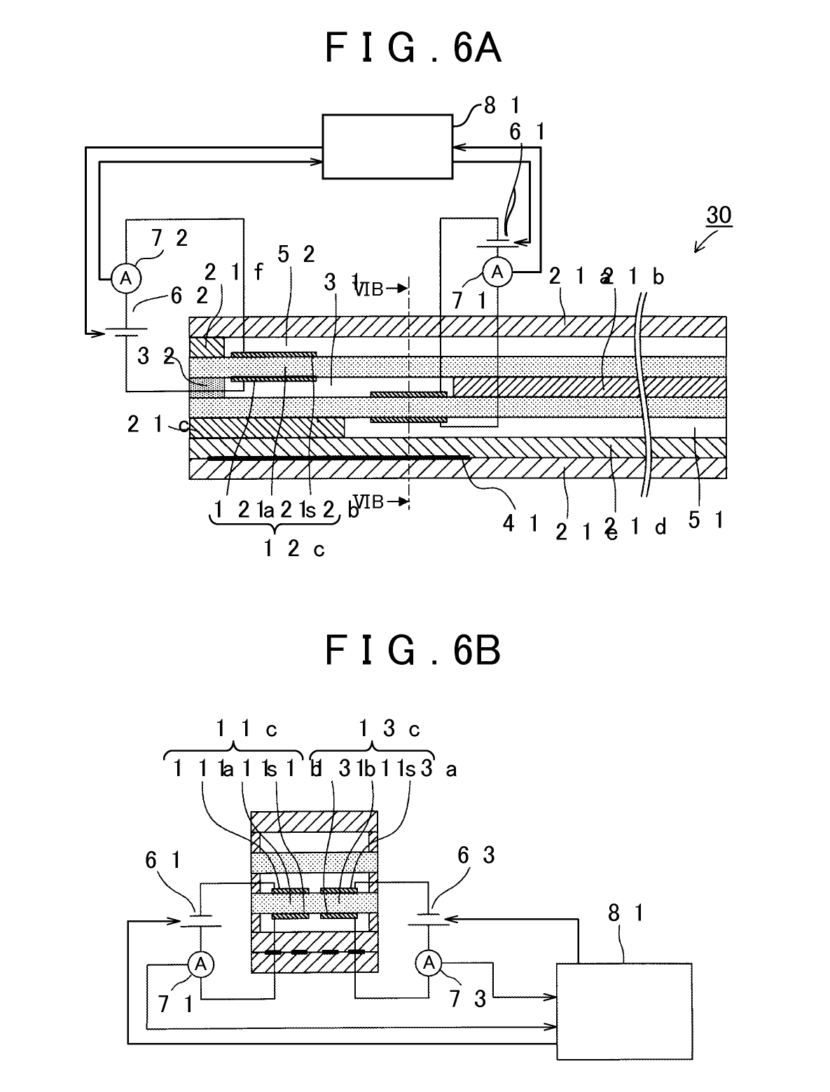

As illustrated in FIGS. 6A and 6B, a gas concentration detecting element 30 of the third device is similar in configuration to the gas concentration detecting element 20 of the second device with the only exception that a third electrochemical cell (pumping cell 13c), which is arranged in the vicinity of the first electrochemical cell (pumping cell 11c), is further provided. Herein, the “vicinity” refers to a region reached by test gas containing water with the concentration equal to the concentration of the water contained in the test gas reaching the first electrochemical cell (pumping cell 11c). The following description of the configuration of the third device will focus on how the third device differs from the second device.

FIG. 6B is a sectional view of the gas concentration detecting element 30 taken along line 6B-6B in FIG. 6A. In the example that is illustrated in FIG. 6B, the third device is further provided with the third electrochemical cell (pumping cell 13c) that is arranged in the vicinity of the first electrochemical cell (pumping cell 11c). Specifically, the first electrochemical cell (pumping cell 11c) and the third electrochemical cell (pumping cell 13c) of the third device are arranged at positions away to the downstream side by the same distance from the second electrochemical cell (pumping cell 12c) arranged on the upstream side.

The third electrochemical cell 13c shares the solid electrolyte body 11s with the first electrochemical cell 11c and has a fifth electrode 13a and a sixth electrode 13b, which are a pair of electrodes arranged on surfaces of the third electrochemical cell 13c. In the example illustrated in FIG. 6, the fifth electrode 13a is arranged to face the internal space 31 and the sixth electrode 13b is arranged to face the first atmospheric air introduction path 51. In other words, the first atmospheric air introduction path 51 functions as a third separate space in this case.

The first electrode 11a is a porous cermet electrode that contains an alloy of platinum (Pt) and rhodium (Rh) as a main component and the second electrode 11b is a porous cermet electrode that contains platinum (Pt) as a main component. The fifth electrode 13a is a porous cermet electrode that contains an alloy of platinum (Pt) and gold (Au) as a main component. The sixth electrode 13b is a porous cermet electrode that contains platinum (Pt) as a main component. The fifth electrode 13a itself is produced for the rate of sulfur oxide decomposition to be lower than in the first electrode 11a even at the same applied voltage. Specifically, the rate at which the sulfur oxide is decomposed in the fifth electrode 13a (second decomposition rate) is substantially 0 (zero).

An electric power supply 63 applies an applied voltage between the fifth electrode 13a and the sixth electrode 13b so that the potential of the sixth electrode 13b exceeds the potential of the fifth electrode 13a. An ammeter 73 outputs, to the ECU 81, a signal correlated with an electrode current flowing through the third electrochemical cell 13c. The ECU 81 can control the applied voltage that is applied to the fifth electrode 13a and the sixth electrode 13b by controlling the electric power supply 63. In the third device, both a third predetermined voltage and the first predetermined voltage are 1.0 V.

The ECU 81 can receive a signal correlated with the electrode current output from the ammeter 73 and flowing through the third electrochemical cell 13c.

As described above, in the third electrochemical cell 13c, the rate of the decomposition of the sulfur oxide contained in the test gas is extremely lower than in the first electrochemical cell 11c despite the application of the applied voltage Vm (1.0 V) equal to that of the first electrochemical cell 11c. Specifically, the rate of the decomposition of the sulfur oxide in the fifth electrode 13a (second decomposition rate) is extremely lower than the rate of the decomposition of the sulfur oxide in the first electrode 11a (first decomposition rate) and is substantially 0 (zero). In other words, the electrode current of the third electrochemical cell includes substantially no current attributable to the decomposition of sulfur oxide. Accordingly, the effect of a change in the concentration of the water contained in the test gas can be reduced based on the difference between the first detected value correlated with the electrode current of the first electrochemical cell 11c and a second detected value correlated with the electrode current of the third electrochemical cell 13c.

Likewise, the rate at which the decomposition product of the sulfur oxide contained in the test gas adsorbs to a cathode is lower in the fifth electrode 13a than in the first electrode 11a. Specifically, no substantial adsorption of the decomposition product of the sulfur oxide occurs in the fifth electrode 13a. Accordingly, the rate of decrease in activity of the fifth electrode 13a with respect to water decomposition is lower than the rate of decrease in activity of the first electrode 11a with respect to water decomposition. Specifically, the activity of the fifth electrode 13a with respect to water decomposition shows no substantial decrease. As a result, the second detected value acquired from the third electrochemical cell 13c exceeds the first detected value acquired from the first electrochemical cell 11c, and the difference between the detected values increases as the concentration of the sulfur oxide contained in the test gas increases.

Accordingly, the third device can accurately detect the concentration of the sulfur oxide contained in the test gas based on the difference between the electrode current Im (first detected value) pertaining to a case where the first predetermined voltage (applied voltage Vm=1.0 V) is applied between the first electrode 11a and the second electrode 11b of the first electrochemical cell 11c and the electrode current Im (second detected value) pertaining to a case where the third predetermined voltage (applied voltage Vm=1.0 V) is applied between the fifth electrode 13a and the sixth electrode 13b of the third electrochemical cell 13c with the difference acquired by a current difference detecting circuit 81.

In the example illustrated in FIG. 6, the third electrochemical cell (pumping cell 13c) shares the solid electrolyte body 11s with the first electrochemical cell (pumping cell 11c). However, the third electrochemical cell (pumping cell 13c) may include a solid electrolyte body that is separate from the solid electrolyte body 11s which constitutes the first electrochemical cell (pumping cell 11c).

In the example illustrated in FIG. 6, the third electrochemical cell (pumping cell 13c) is arranged in the vicinity of the first electrochemical cell (pumping cell 11c). However, the positional relationship of the pumping cells is not particularly limited insofar as the concentration of the sulfur oxide contained in the test gas can be detected based on the difference between the first detected value and the second detected value acquired from the pumping cells. In addition, the voltage that is applied between the electrodes so that the second detected value is acquired from the third electrochemical cell (pumping cell 13c) is not particularly limited insofar as the concentration of the sulfur oxide contained in the test gas can be detected based on the difference between the first detected value and the second detected value.

In the third device, the third predetermined voltage is equal to the first predetermined voltage (specifically, 1.0 V). However, the third predetermined voltage is not particularly limited insofar as the third predetermined voltage is a predetermined voltage that allows the decomposition of the water contained in the test gas when applied between the fifth electrode 13a and the sixth electrode 13b in a case where the fifth electrode 13a is a cathode and the sixth electrode 13b is an anode as described above.

As described above, the decomposition of another component contained in the test gas (such as carbon dioxide (CO₂)) and/or the solid electrolyte body 11s may occur when the applied voltage Vm is excessively high. Accordingly, it is desirable that the third predetermined voltage is a predetermined voltage exceeded by the lower limit voltage of the limiting current region of the water. In other words, it is desirable that the third predetermined voltage is a predetermined voltage equal to or higher than the decomposition initiation voltage of the water and lower than the lower limit of the voltage range in which the limiting current characteristics of the water are expressed (observed).

In the third device, the magnitude of the electrode current flowing between the fifth electrode 13a and the sixth electrode 13b when the third predetermined voltage is applied between the fifth electrode 13a and the sixth electrode 13b is the second detected value. However, the second detected value is not particularly limited insofar as the second detected value is the value of any signal correlated with the electrode current (examples including a voltage value, a current value, and a resistance value) as described above.

In the third device, the fifth electrode 13a is a porous cermet electrode that contains an alloy of platinum (Pt) and gold (Au) as a main component and the sixth electrode 13b is a porous cermet electrode that contains platinum (Pt) as a main component. However, the material that constitutes the fifth electrode 13a is not particularly limited insofar as reductive decomposition can be performed on the water contained in the test gas introduced into the internal space 31 via the diffusion resistance unit 32 when the third predetermined voltage is applied between the fifth electrode 13a and the sixth electrode 13b. Preferably, the material that constitutes the fifth electrode 13a contains, as a main component, a metallic element such as platinum (Pt), gold (Au), lead (Pb), and silver (Ag) or an alloy thereof. More preferably, the fifth electrode 13a is a porous cermet electrode that contains, as a main component, at least one selected from the group consisting of platinum (Pt), gold (Au), lead (Pb), and silver (Ag).

In the third device, the rate at which the sulfur oxide is decomposed in the fifth electrode 13a (second decomposition rate) is substantially 0 (zero). However, the effect of a change in the concentration of the water contained in the test gas can be reduced to some extent, even in a case where the second decomposition rate is not substantially 0 (zero), when the difference between the first detected value and the second detected value is used. As a result, the accuracy of the detection of the concentration of the sulfur oxide contained in the test gas can be improved.

Any one or more of the first electrochemical cell, the second electrochemical cell (in a case where the gas concentration detecting element is provided with the second electrochemical cell), and the third electrochemical cell (in a case where the gas concentration detecting element is provided with the third electrochemical cell) described above can be used as an air-fuel ratio sensor. In this case, an applied voltage correlated with the limiting current region of oxygen is set in any one or more of the electrochemical cells. The concentration of the oxygen contained in the exhaust gas from the internal combustion engine as the test gas is detected based on the detected value correlated with the electrode current pertaining to this case. The air-fuel ratio of the air-fuel mixture in the combustion chamber of the internal combustion engine correlated with the test gas can be detected based on the concentration of the oxygen in the exhaust gas detected in this manner.

In this case, an applied voltage correlated with the limiting current region of oxygen needs to be applied to the electrochemical cell as described above for the air-fuel ratio of the air-fuel mixture in the combustion chamber of the internal combustion engine to be detected based on the detected value acquired in the one or more electrochemical cells. Accordingly, it is basically desirable that the air-fuel ratio is detected when the SOx concentration detection processing by the device according to the invention is not executed.

The air-fuel ratio can be detected despite the execution of the SOx concentration detection processing by the device according to the invention in a case where the gas concentration detecting element is provided with the second electrochemical cell and the applied voltage correlated with the limiting current region of the oxygen is applied in the second electrochemical cell. In addition, the concentration of the sulfur oxide contained in the test gas can be further accurately detected when the first detected value and/or the second detected value are/is corrected based on the concentration of the oxygen contained in the test gas which is detected as described above.

The concentration of the oxygen contained in the exhaust gas discharged from the internal combustion engine changes depending on the air-fuel ratio of the air-fuel mixture combusted in the combustion chamber of the internal combustion engine. Accordingly, it is desirable that the first detected value is detected when the air-fuel ratio of the air-fuel mixture combusted in the combustion chamber of the internal combustion engine is maintained at a predetermined value, examples of which include during a steady operation of the internal combustion engine, for the concentration of the sulfur oxide contained in the test gas to be accurately detected based on the first detected value.

Several embodiments and modification examples that have specific configurations have been described with reference to the accompanying drawings for the description of the invention. However, the scope of the invention is not limited to the exemplary embodiments and modification examples, and appropriate changes can be added thereto without departing from the scope of claims and the specification.

What is claimed is:

1. A gas concentration detecting device comprising:
a gas concentration detecting element including a first electrochemical cell, a dense body and a diffusion resistance unit, the first electrochemical cell including a first solid electrolyte body, a first electrode and a second electrode, the first solid electrolyte body having oxide ion conductivity, the first electrode and the second electrode being arranged on respective surfaces of the first solid electrolyte body, the first solid electrolyte body, the dense body and the diffusion resistance unit being configured to define an internal space, the diffusion resistance unit being configured to introduce exhaust gas from an internal combustion engine as test gas into the internal space via the diffusion resistance unit, the first electrode being exposed to the internal space, the second electrode being exposed to a first separate space as a space other than the internal space, and the first electrode being configured to decompose water and sulfur oxide contained in the test gas when a first predetermined voltage is applied to a first electrode pair of the first electrode and the second electrode;
a first current detector configured to output a first detected value correlated with a current flowing through the first electrode pair;
a first electric power supply configured to apply a voltage to the first electrode pair; and
an electronic control unit configured to:
(i) control the first electric power supply such that the first predetermined voltage is applied to the first electrode pair;
(ii) acquire the first detected value from the first current detector when the first predetermined voltage is applied to the first electrode pair; and
(iii) detect the concentration of the sulfur oxide contained in the test gas based on the first detected value.

2. The gas concentration detecting device according to claim 1,
wherein the electronic control unit is configured to control the first electric power supply such that a predetermined voltage lower than a lower limit voltage of a limiting current region of water is applied to the first electrode pair as the first predetermined voltage.

3. The gas concentration detecting device according to claim 1,
wherein the electronic control unit is configured to control the first electric power supply such that a predetermined voltage of equal to or higher than 0.6 V is applied to the first electrode pair as the first predetermined voltage.

4. The gas concentration detecting device according to claim 1,
wherein the electronic control unit is configured to acquire a magnitude of the current flowing through the first electrode pair as the first detected value when the first predetermined voltage is applied to the first electrode pair.

5. The gas concentration detecting device according to claim 4,
wherein the electronic control unit is configured to detect a higher concentration value of the concentration of the sulfur oxide contained in the test gas as the first detected value decreases.

6. The gas concentration detecting device according to claim 1,
wherein the first electrode contains at least one selected from the group consisting of platinum, rhodium, and palladium.

7. The gas concentration detecting device according to claim 1, further comprising:
a second electric power supply,
wherein the gas concentration detecting element includes a second electrochemical cell, the second electrochemical cell includes a second solid electrolyte body, a third electrode and a fourth electrode, the second solid electrolyte body has oxide ion conductivity, the third electrode and the fourth electrode are arranged on respective surfaces of the second solid electrolyte body, the third electrode is exposed to the internal space, the fourth electrode is exposed to a second separate space as a space other than the internal space, the third electrode is arranged at a position in the internal space closer to the diffusion resistance unit than the first electrode is, and the third electrode is configured to discharge oxygen from the internal space or introduce oxygen into the internal space when a second predetermined voltage is applied to a second electrode pair of the third electrode and the fourth electrode,
wherein the second electric power supply is configured to apply a voltage to the second electrode pair, and
wherein the electronic control unit is configured to control the second electric power supply such that the second predetermined voltage is applied to the second electrode pair, the electronic control unit being configured to acquire the first detected value from the first current detector when the concentration of the oxygen in the internal space is adjusted to a predetermined concentration with the second predetermined voltage applied to the second electrode pair and when the first predetermined voltage is applied to the first electrode pair.

8. The gas concentration detecting device according to claim 7,
wherein the electronic control unit is configured to control the second electric power supply such that a predetermined voltage equal to or higher than a decomposition initiation voltage of oxygen and lower than a decomposition initiation voltage of water is applied to the second electrode pair as the second predetermined voltage.

9. The gas concentration detecting device according to claim 1, further comprising:
a third current detector; and
a third electric power supply,
wherein the gas concentration detecting element includes a third electrochemical cell, the third electrochemical cell includes a third solid electrolyte body, a fifth electrode and a sixth electrode, the third solid electrolyte body has oxide ion conductivity, the fifth electrode and the sixth electrode are arranged on respective surfaces of the third solid electrolyte body, the fifth electrode is exposed to the internal space, the sixth electrode is exposed to a third separate space as a space other than the internal space, the fifth electrode is configured such that a second decomposition rate as a rate of sulfur oxide decomposition by the third electrochemical cell pertaining to a case where a third predetermined voltage is applied to a third electrode pair of the fifth electrode and the sixth electrode is lower than a first decomposition rate as a rate of sulfur oxide decomposition by the first electrochemical cell pertaining to a case where the first predetermined voltage is applied to the first electrode pair,
wherein the third current detector is configured to output a third detected value correlated with a current flowing through the third electrode pair,
wherein the third electric power supply is configured to apply a voltage to the third electrode pair,
wherein the electronic control unit is configured to control the third electric power supply such that the third predetermined voltage is applied to the third electrode pair,
wherein the electronic control unit is configured to acquire the third detected value from the third current detector, and
wherein the electronic control unit is configured to detect the concentration of the sulfur oxide contained in the test gas based on a difference between the first detected value acquired when the first predetermined voltage is applied to the first electrode pair and the third detected value acquired when the third predetermined voltage is applied to the third electrode pair.

10. The gas concentration detecting device according to claim 9,
wherein the electronic control unit is configured to control the third electric power supply such that a predetermined voltage equal to or higher than a decomposition initiation voltage of water and lower than a lower limit voltage of a limiting current region of water is applied to the third electrode pair as the third predetermined voltage.

11. The gas concentration detecting device according to claim 9,
wherein the electronic control unit is configured to control the third electric power supply such that the voltage equal to the first predetermined voltage is applied to the third electrode pair as the third predetermined voltage.

12. The gas concentration detecting device according to claim 9,
wherein the fifth electrode is arranged in a region reached by test gas containing water with the concentration equal to the concentration of the water contained in the test gas reaching the first electrode.

13. The gas concentration detecting device according to claim 9,
wherein the electronic control unit acquires the third detected value from the third current detector when the third predetermined voltage is applied to the third electrode pair.

14. The gas concentration detecting device according to claim 13,
wherein the electronic control unit is configured to detect a higher concentration value of the concentration of the sulfur oxide contained in the test gas as a absolute value of a difference between the first detected value and a second detected value increases.

15. The gas concentration detecting device according to claim 9,
wherein the fifth electrode contains at least one selected from the group consisting of platinum, gold, lead, and silver.

16. The gas concentration detecting device according to claim 1,
wherein the electronic control unit is configured to control the first electric power supply such that a fourth predetermined voltage as a predetermined voltage lower than a decomposition initiation voltage of water is applied to the first electrode pair, and
wherein the electronic control unit is configured to detect an air-fuel ratio of an air-fuel mixture in a combustion chamber of the internal combustion engine correlated with the test gas based on the first detected value correlated with the current flowing through the first electrode pair when the fourth predetermined voltage is applied.

17. The gas concentration detecting device according to claim 7,
wherein the electronic control unit is configured to control at least one of the first electric power supply and the second electric power supply such that a fourth predetermined voltage as a predetermined voltage lower than a decomposition initiation voltage of water is applied to at least one of the first electrode pair or the second electrode pair, and
wherein the electronic control unit is configured to detect an air-fuel ratio of an air-fuel mixture in a combustion chamber of the internal combustion engine correlated with the test gas based on a detected value correlated with a current flowing through the first electrode pair or the second electrode pair to which the fourth predetermined voltage is applied.

18. The gas concentration detecting device according to claim 9,
wherein the electronic control unit is configured to control at least one of the first electric power supply, the second electric power supply or the third electric power supply such that a fourth predetermined voltage as a predetermined voltage lower than a decomposition initiation voltage of water is applied to at least one of the first electrode pair, the second electrode pair or the third electrode pair, and
wherein the electronic control unit is configured to detect the air-fuel ratio of an air-fuel mixture in a combustion chamber of the internal combustion engine correlated with the test gas based on a detected value correlated with a current flowing through the first electrode pair, the second electrode pair or the third electrode pair to which the fourth predetermined voltage is applied.
